(19) United States
(12) Patent Application Publication
(10) Pub. No.: US 2026/0004789 A1
(43) Pub. Date: Jan. 1, 2026

(54) AUDIO DATA TRANSMISSION/RECEPTION DEVICE BASED ON MULTI-POINT WIRELESS COMMUNICATION AND OPERATION METHOD THEREOF

(71) Applicant: Samsung Electronics Co., Ltd., Suwon-si (KR)

(72) Inventors: Hyunchul YANG, Suwon-si (KR); Hyunwook KIM, Suwon-si (KR); Hangil MOON, Suwon-si (KR); Jaeha PARK, Suwon-si (KR); Sanghoon LEE, Suwon-si (KR); Seung HEO, Suwon-si (KR)

(21) Appl. No.: 19/188,998

(22) Filed: Apr. 24, 2025

Related U.S. Application Data
(63) Continuation of application No. PCT/KR2025/095217, filed on Apr. 16, 2025.

(30) Foreign Application Priority Data
Jun. 27, 2024 (KR) 10-2024-0084644
Jul. 9, 2024 (KR) 10-2024-0090792

(51) Int. Cl. G10L 19/002; G06F 3/16; G10L 19/008; H04W 4/80

(52) U.S. Cl. CPC G10L 19/002; G10L 19/008; H04W 4/80; G06F 3/162

(57) ABSTRACT

An electronic device may comprise a communication comprising communication circuitry configured to support simultaneous wireless connection with a plurality of external electronic devices, memory, and at least one processor comprising processing circuitry. The memory may store instructions, wherein at least one processor, individually and/or collectively, is configured to control the electronic device to: identify at least one external electronic device wirelessly connected with the electronic device in response to a request for playing first audio data for a first external electronic device wirelessly connected with the electronic device, determine a first bitrate for transmitting the first audio data based on a remaining bandwidth range except for a bandwidth used for maintaining the wireless connection with the identified at least one external electronic device, generate a first audio packet by encoding the first audio data based on a current bitrate in response to determining that the current bitrate is less than or equal to the first bitrate, and transmit the first audio packet to the first external electronic device through the communication module.

### CROSS-REFERENCE TO RELATED APPLICATIONS

This application is a continuation of International Application No. PCT/KR2025/095217 designating the United States, filed on Apr. 16, 2025, in the Korean Intellectual Property Receiving Office, and claiming priority to Korean Patent Application Nos. 10-2024-0084644, filed on Jun. 27, 2024, and 10-2024-0090792, filed on Jul. 9, 2024, in the Korean Intellectual Property Office, the disclosures of each of which are incorporated by reference herein in their entireties.

### BACKGROUND

### Field

The disclosure relates to an audio data transmission/reception device and an operation method thereof.

### Description of Related Art

Audio streaming technology between heterogeneous devices through wireless network connections has become widespread. For example, a user terminal, such as a smartphone, may be connected to an output device, such as a wireless headphone/speaker, via Bluetooth wireless connection, and output music through the wireless headphone or speaker using the wireless connection.

### SUMMARY

An electronic device according to an example embodiment of the disclosure may comprise: a communication module comprising communication circuitry configured to support simultaneous wireless connection with a plurality of external electronic devices, memory, and at least one processor including processing circuitry, wherein the memory may store instructions, at least one processor, individually and/or collectively configured to execute the instructions and to cause the electronic device to: identify at least one external electronic device wirelessly connected with the electronic device in response to a request for playing first audio data for a first external electronic device wirelessly connected with the electronic device, determine a first bitrate for transmitting the first audio data based on a remaining bandwidth range except for a bandwidth used for maintaining the wireless connection with the identified at least one external electronic device, generate a first audio packet by encoding the first audio data based on a current bitrate in response to determining that the current bitrate is less than or equal to the first bitrate, and transmit the first audio packet to the first external electronic device through the communication module.

According to an example embodiment, at least one processor, individually and/or collectively, is configured to cause the electronic device to: maintain the wireless connection between the electronic device and the at least one external electronic devices based on Bluetooth multi-point connection through the communication module while transmitting the first audio packet to the first external electronic device.

According to an example embodiment, at least one processor, individually and/or collectively is configured to cause the electronic device to connect each of the at least one external electronic device to the electronic device based on a first protocol.

According to an example embodiment, at least one processor, individually and/or collectively, is configured to cause the electronic device to: transmit a data signal for identifying a network connection state to the first external electronic device among the at least one external electronic device wirelessly connected with the electronic device every specified first period through the communication module; and maintain Bluetooth multi-point-based wireless connection between the electronic device and the first external electronic device in response to receiving a response signal within a specified time from the first external electronic device.

According to an example embodiment, at least one processor, individually and/or collectively, is configured to cause the electronic device to change the current bitrate to be less than the first bitrate in response to determining that the current bitrate is greater than the first bitrate.

According to an example embodiment, at least one processor, individually and/or collectively, is configured to cause the electronic device to: in response to determining that a difference between the current bitrate and the first bitrate is greater than a first reference, compress the first audio data into a sound quality lower than a current sound quality and encode at the changed current bitrate.

According to an example embodiment, at least one processor, individually and/or collectively, is configured to cause the electronic device to: in response to determining that the first bitrate is less than a specified threshold, release connection to at least one among the at least one external electronic device wirelessly connected with the electronic device.

According to an example embodiment, the electronic device may further comprise a display, wherein at least one processor, individually and/or collectively, is configured to cause the electronic device to: display, through the display, a screen including information about the at least one external electronic device simultaneously connected with the electronic device or a message related to releasing the connection.

According to an example embodiment, the memory may store instructions, when executed individually and/or collectively by the at least one processor, enabling the electronic device to change the current bitrate in response to receiving a request for changing a bitrate of receiving the first audio packet from the first external electronic device.

According to an example embodiment, at least one processor, individually and/or collectively, is configured to cause the electronic device to release wireless connection with the first external electronic device in response to a distance to the first external electronic device among the at least one external electronic device being outside a communicable range.

An electronic device according to an example embodiment of the disclosure may comprise: a speaker, a communication module comprising communication circuitry configured to support simultaneous wireless connection with a plurality of external electronic devices, memory, and at least one processor including processing circuitry. The memory may store instructions, at least one processor, individually and/or collectively is configured to execute the instructions and to cause the electronic device to: receive a first audio packet from a first external electronic device among at least one external electronic device wirelessly connected with the electronic device through the communication module, increase a size of a reception buffer in response to determining that a bitrate applied to the first audio packet is greater than a bitrate of controlling the reception buffer, and output audio data decoded from the first audio packet through the speaker.

According to an example embodiment, at least one processor, individually and/or collectively, is configured to cause the electronic device to maintain the wireless connection between the electronic device and the at least one external electronic device based on Bluetooth multi-point connection through the communication module while receiving the first audio packet.

According to an example embodiment, at least one processor, individually and/or collectively, is configured to cause the electronic device to connect each of the at least one external electronic device to the electronic device based on a first protocol.

According to an example embodiment, at least one processor individually and/or collectively, is configured to cause the electronic device to: transmit a data signal for identifying a network connection state to the first external electronic device among the at least one external electronic device wirelessly connected with the electronic device every specified first period through the communication module; and maintain Bluetooth multi-point-based wireless connection between the electronic device and the first external electronic device in response to receiving a response signal within a specified time from the first external electronic device.

According to an example embodiment, at least one processor, individually and/or collectively, is configured to cause the electronic device to: determine the reception buffer control bitrate to store or process the received first audio packet based on an unused portion other than for a portion used to maintain the wireless connection with the at least one external electronic device wirelessly connected with the electronic device, of the reception buffer of the electronic device.

According to an example embodiment, at least one processor, individually and/or collectively, is configured to cause the electronic device to: perform upsampling on the decoded audio data in response to determining that a bitrate applied to the first audio packet is less than a first threshold.

According to an example embodiment, at least one processor, individually and/or collectively by, is configured to cause the electronic device to: perform upsampling on the decoded audio data in response to determining that the decoded audio data has a sound quality lower than an original sound quality of the first audio packet.

According to an example embodiment, at least one processor, individually and/or collectively, is configured to cause the electronic device to: in response to determining that a size of the reception buffer is greater than a first reference size, release connection to at least one among the at least one external electronic device wirelessly connected with the electronic device.

According to an example embodiment, at least one processor, individually and/or collectively, is configured to cause the electronic device to: in response to determining that a size of the reception buffer is greater than a first reference size, transmit a request for changing the bitrate applied to the first audio packet to the first external electronic device.

According to an example embodiment, the electronic device may be a wearable true wireless stereo device.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an example electronic device in a network environment according to one or more embodiment(s);

FIG. 2 is a block diagram illustrating an example configuration of a data transmission device and a data reception device wirelessly connected according to one or more embodiment(s);

FIG. 3 is a diagram illustrating a plurality of electronic devices in a wireless connection network environment according to one or more embodiment(s);

FIG. 4 is a signal flow diagram illustrating an example audio data transmission/reception method of electronic devices Bluetooth multi-point connected according to one or more embodiment(s);

FIG. 5 is a flowchart illustrating an example operation of transmitting data to a wirelessly connected external playback device by an electronic device according to one or more embodiment(s);

FIG. 6 is a diagram illustrating an example of bandwidth use information according to a multi-point connection according to one or more embodiment(s);

FIG. 7 is a flowchart illustrating an example operation of receiving data from a wirelessly connected electronic device and playing the data by a playback device according to one or more embodiment(s);

FIG. 8 is a diagram illustrating an example of changing a data reception buffer size by a data reception device according to one or more embodiment(s);

FIG. 9 is a diagram illustrating an example of using a bandwidth by a data transmission device and a data reception device wirelessly connected, according to one or more embodiment(s);

FIG. 10 is a diagram illustrating an example of a multi-point connection circumstance between a plurality of electronic devices according to one or more embodiment(s); and

FIG. 11 is a diagram illustrating an example of a Bluetooth connection alarm screen of an electronic device according to one or more embodiment(s).

### DETAILED DESCRIPTION

Hereinafter, various example embodiments of the disclosure are described in greater detail with reference to the drawings. However, the disclosure may be implemented in other various forms and is not limited to the example embodiments set forth herein. The same or similar reference denotations may be used to refer to the same or similar elements throughout the disclosure and the drawings. Further, for clarity and brevity, descriptions of well-known functions and configurations in the drawings and relevant descriptions may be omitted.

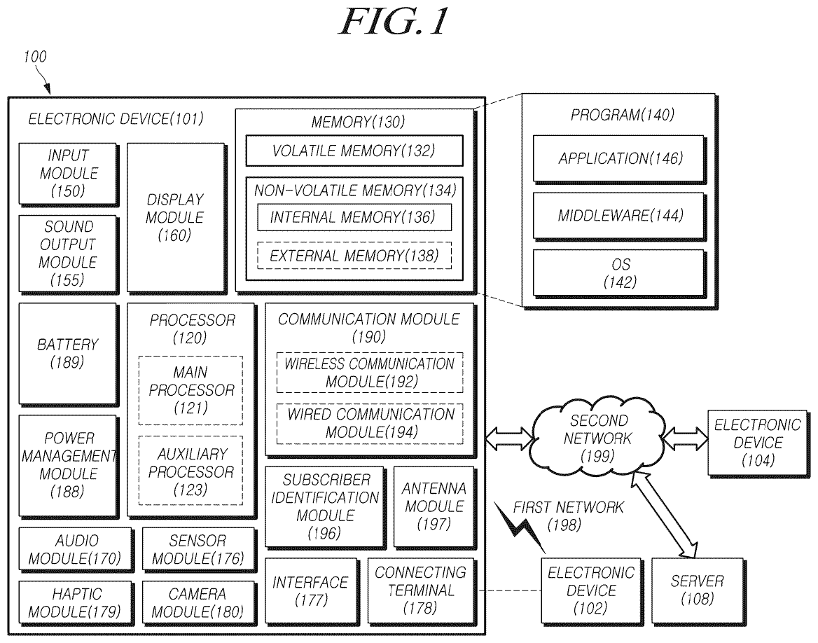

FIG. 1 is a block diagram illustrating an example electronic device in a network environment according to one or more embodiment(s).

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a communication module 192 (e.g., a cellular communication module, a short-range communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The communication module 192 may identify or authenticate the electronic device 101 in a communication network, such as the first network 198 or the second network 199, using subscriber information (e.g., international mobile subscriber identity (IMSI)) stored in the subscriber identification module 196.

The communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The communication module 192 may support a high-frequency band (e.g., the mmWave band) to achieve, e.g., a high data transmission rate. The communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The communication module 192 may support various requirements specified in the electronic device 101, an external electronic device (e.g., the electronic device 104), or a network system (e.g., the second network 199). According to an embodiment, the communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

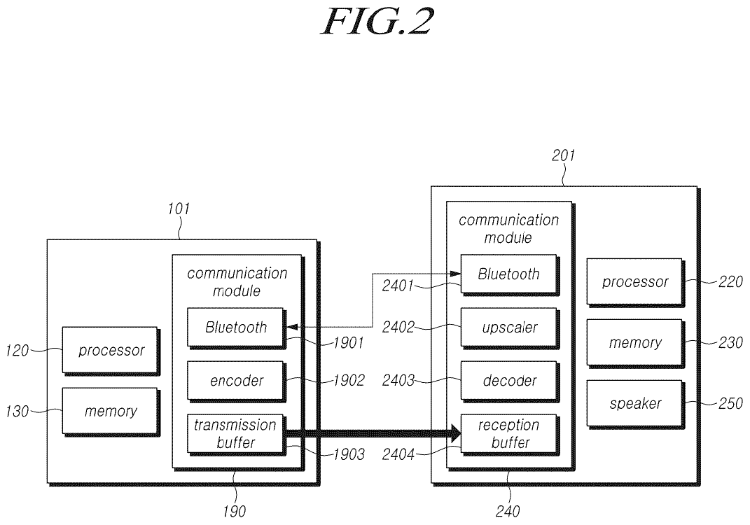

FIG. 2 is a block diagram illustrating an example configuration of a data transmission device and a data reception device wirelessly connected according to one or more embodiment(s).

According to an embodiment, the electronic device 101 may use a wirelessly connected playback device 201 (or the electronic device 201) for audio output. In various embodiments of the disclosure, for convenience of description, the electronic device 101 that transmits audio data may be referred to as a data transmission device or a data providing device, and the electronic device 201 that receives audio data and outputs it through a speaker may be referred to as a data reception device or a playback device. The electronic device 101 and the playback device 201 may be the same electronic device or different types of electronic devices. Further, the electronic device 101 and the playback device 201 may include at least some of the components of the electronic device 101 of FIG. 1.

According to an embodiment, the electronic device 101 may include a processor (e.g., including processing circuitry) 120, memory 130, and a communication module (e.g., including communication circuitry) 190. The communication module 190 may include various communication circuitry including a Bluetooth communication module 1901 supporting Bluetooth wireless connection, an encoder 1902 encoding audio data, and a transmission buffer 1903 for transmitting encoded audio packets. Some components of the communication module 190 may be operated by the processor 120 or a separate component.

The playback device 201 according to an embodiment may include a processor (e.g., including processing circuitry) 220, memory 230, a communication module (e.g., including communication circuitry) 240, and a speaker 250. The communication module 240 may include various communication circuitry including a reception buffer 2401 that receives audio packets, a decoder 2402 that decodes audio packets, an upscaler 2403 that performs upscaling on decoded audio data, and a Bluetooth communication module 2404 that supports Bluetooth wireless connection. Some components of the communication module 240 may be operated by the processor 220 or a separate component.

The Bluetooth communication module 1901 may support various profiles (e.g., A2DP or HFP) for executing various functions (e.g., audio transmission or voice call management). Advanced audio distribution profile (A2DP) is a protocol used to transmit high-quality stereo audio, such as song play. Hands-free profile (HFP) is a protocol used for voice communication, such as telephone calls.

For example, electronic device A may transmit and receive audio signals through the first profile (e.g., A2DP) with electronic device B that supports Bluetooth, and may transmit and receive data for phone calls through the second profile (e.g., HFP). Electronic device A may receive a phone call from electronic device B (or electronic device C) through the second profile while receiving an audio signal from electronic device B through the first profile. However, when electronic device A receives an audio signal from electronic device C through the first profile while receiving an audio signal from electronic device B through the first profile, it may be necessary to terminate the Bluetooth connection with electronic device A and set up a separate Bluetooth connection with device B.

The electronic device 101 and the playback device 2010, according to an embodiment of the disclosure, may support a Bluetooth multi-point wireless connection, capable of data communication with a plurality of devices through the same protocol. In Bluetooth wireless communication, a Bluetooth multi-point connection may refer, for example, to a function in which one device is connected to a plurality of Bluetooth devices at the same time. For example, a playback device 201 capable of Bluetooth multi-point connection may be connected to the first electronic device 101 and the second electronic device (not shown) at the same time, and if an audio signal is received from the second electronic device (not shown) while receiving an audio signal from the first electronic device 101, there is no need to establish a separate Bluetooth connection.

The electronic device 101 and the playback device 201 may include Bluetooth communication modules 1901 and 2401, each including various Bluetooth circuitry supporting multi-point connection, and may be wirelessly connected to each other by multi-point connection. The electronic device 101 may be connected to other Bluetooth devices in addition to the playback device 201 at the same time. The playback device 201 may be simultaneously connected to other Bluetooth devices in addition to the electronic device 101.

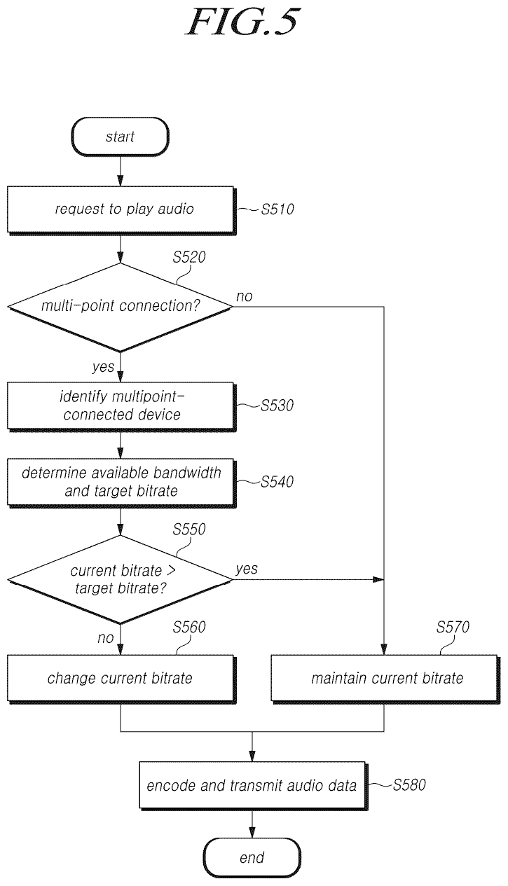

An electronic device according to an example embodiment of the disclosure may comprise: a communication module comprising communication circuitry configured to support simultaneous wireless connection with a plurality of external electronic devices, memory, and at least one processor comprising processing circuitry. The memory may store instructions, wherein at least one processor, individually and/or collectively, is configured to execute the instructions and to cause (or control) the electronic device to: identify at least one external electronic device wirelessly connected with the electronic device in response to a request for playing first audio data for a first external electronic device wirelessly connected with the electronic device, determine a first bitrate for transmitting the first audio data based on a remaining bandwidth range except for a bandwidth used for maintaining the wireless connection with the identified at least one external electronic device, generate a first audio packet by encoding the first audio data based on a current bitrate in response to determining that the current bitrate is less than or equal to the first bitrate, and transmit the first audio packet to the first external electronic device through the communication module. An embodiment of determining the first bitrate may correspond to determining a target bitrate in an embodiment described in greater detail below with reference to FIG. 5.

The electronic device 101, according to an embodiment, may maintain the wireless connection between the electronic device 101 and the at least one external electronic devices, based on Bluetooth multi-point connection, through the communication module 190 while transmitting the first audio packet to the first external electronic device 201.

The electronic device 101 according to an embodiment may be connected to each of the at least one external electronic device based on a first protocol (e.g., A2DP).

The electronic device 101, according to an embodiment, may transmit a data signal every predetermined (e.g., specified) first period (e.g., a wireless connection identification period) through the communication module 190 to determine a network connection state of the first external electronic device, among the at least one external electronic device, wirelessly connected with the electronic device and maintain Bluetooth multi-point-based wireless connection between the electronic device 101 and the first external electronic device after receiving a response signal within a predetermined (e.g., specified) time from the first external electronic device.

The electronic device 101 according to an embodiment may change the current bitrate to be less than the first bitrate in response to determining that the current bitrate is greater than the first bitrate.

The electronic device 101 according to an embodiment may, in response to determining that a difference between the current bitrate and the first bitrate is greater than a first reference, compress the first audio data into a sound quality lower than a current sound quality and then encode at the changed current bitrate.

The electronic device 101 according to an embodiment may, in response to determining that the first bitrate is less than a predetermined (e.g., specified) threshold, release connection with at least one external electronic device among at least one external electronic device wirelessly connected with the electronic device.

The electronic device 101 may further comprise a display and display (e.g., output or show), through the display, a screen including information about the at least one external electronic device simultaneously connected with the electronic device 101 or a message related to releasing the connection.

The electronic device 101 according to an embodiment may change the current bitrate in response to receiving a request for changing a bitrate of receiving the first audio packet from the first external electronic device 201.

The electronic device 101, according to an embodiment, may release Bluetooth multi-point-based wireless connection with the first external electronic device among at least one external electronic device if a distance to the first external electronic device falls (e.g., located) outside a communicable range.

A playback device (e.g., the electronic device 201) according to an example embodiment may comprise: a speaker, a communication module comprising communication circuitry configured to support simultaneous wireless connection with a plurality of external electronic devices, memory, and at least one processor comprising processing circuitry. The memory may store the instructions, wherein at least one processor, individually and/or collectively, may be configured to execute the instructions and to cause (or control) the electronic device to: receive a first audio packet from a first external electronic device among at least one external electronic device wirelessly connected with the electronic device through the communication module, increase a size of a reception buffer in response to determining that a bitrate applied to the first audio packet is greater than a bitrate of controlling the reception buffer, and output audio data decoded from the first audio packet through the speaker.

The electronic device 201, according to an embodiment, may maintain the wireless connection between the electronic device 201 and the at least one external electronic devices based on Bluetooth multi-point connection through the communication module 240 while receiving the first audio packet.

The electronic device 201, according to an embodiment, may be connected to each of the at least one external electronic device based on a first protocol (e.g., A2DP).

The electronic device 201, according to an embodiment, may transmit a data signal every predetermined (e.g., specified) first period through the communication module 240 to determine a network connection state of the first external electronic device, among the at least one external electronic device wirelessly connected with the electronic device and maintain Bluetooth multi-point-based wireless connection between the electronic device and the first external electronic device after receiving a response signal within a predetermined (e.g., specified) time from the first external electronic device.

The electronic device 201, according to an embodiment, may determine the reception buffer control bitrate to store or process the received first audio packet based on a remaining (e.g., unused) portion other than for a portion used to maintain the wireless connection with the at least one external electronic device wirelessly connected with the electronic device 201, of the reception buffer of the electronic device 201.

The electronic device 201, according to an embodiment, may perform up-sampling on the decoded audio data in response to determining that a bitrate applied to the first audio packet is less than a first threshold.

The electronic device 201, according to an embodiment, may perform up-sampling on the decoded audio data after determining that the decoded audio data has a sound quality lower than an original sound quality of the first audio packet.

The electronic device 201, according to an embodiment, may, after determining that a size of the reception buffer is greater than a first reference size, release connection to at least one external electronic device among the at least one external electronic device wirelessly connected with the electronic device 201.

In an embodiment, the electronic device 201 may, after determining that a size of the reception buffer is greater than a first reference size, transmit a request for changing the bitrate applied to the first audio packet to the first external electronic device 101.

According to an embodiment, the electronic device 201 may be a wearable true wireless stereo device.

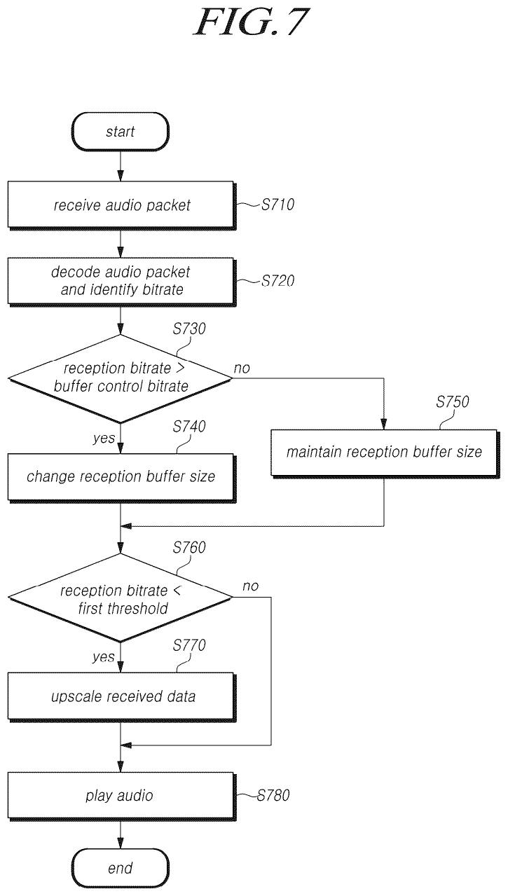

The example embodiments of FIG. 2 may be combined with FIG. 1 or FIGS. 3 to 11. The configuration of the electronic device 101 and the playback device 201 of FIG. 2 may be identical in whole or part to the configuration of the electronic device 101 of FIG. 1. The configuration of the electronic device 101 of FIG. 2 may perform all or some of the operations of the electronic device 101 of FIG. 5. The configuration of the playback device 201 of FIG. 2 may perform all or some of the operations of the electronic device 201 of FIG. 7.

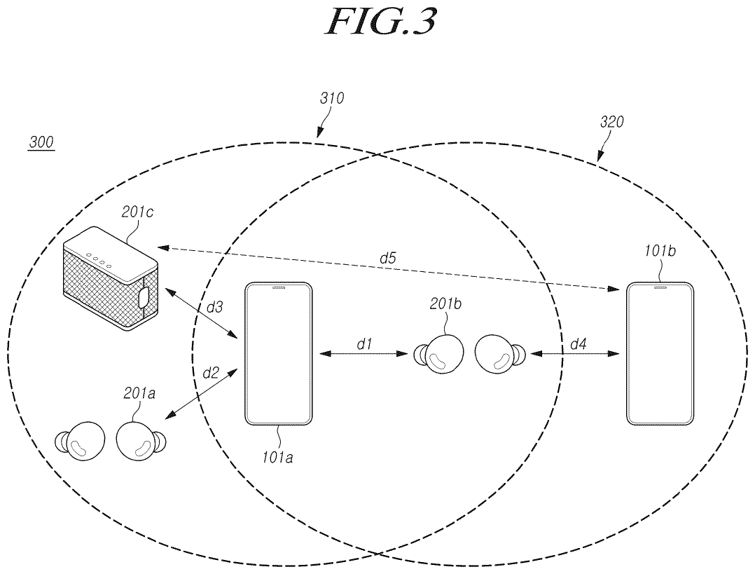

FIG. 3 is a diagram illustrating a plurality of electronic devices in a wireless connection network environment according to various embodiments.

According to an embodiment, a plurality of electronic devices in the wireless connection network environment 300 may be simultaneously connected to each other based on (e.g., using) a Bluetooth multi-point connection. The plurality of electronic devices may include a data transmission device for playing audio data, and a data reception device (or a playback device) for receiving and outputting audio data. For convenience of description, a data transmission device and a data reception device are described, but the components of the electronic devices are not limited, and each electronic device is capable of both data transmission and data reception and output data (e.g., audio signals) through various output devices (e.g., speakers).

Referring to FIG. 3, the mobile electronic device (e.g., the first electronic device 101a, the second electronic device 101b) (e.g., the electronic device 101 of FIG. 2) may transmit an audio signal to the playback devices 201a, 201b, or 201c (e.g., the playback device 201 of FIG. 2) for audio play. The playback device 201a, 201b, or 201c may output the received audio signal through the speaker of the playback device 201a, 201b, or 201c.

Bluetooth wireless communication may refer, for example, to short-range wireless communication, and is capable of wireless connection only within a communicable (e.g., limited) range. In FIG. 3, the first electronic device 101a may be simultaneously connected to the first playback device 201a, the second playback device 201b, and the third playback device 201c positioned within a first range 310 capable of Bluetooth wireless communication, as shown by distance d2, distance d1, and distance d3, respectively. The distance d1 between the first electronic device 101a and the second playback device 201b, the distance d2 between the first electronic device 101a and the first playback device 201a, and the distance d3 between the first electronic device 101a and the third playback device 201c are included in the first range 310 within which Bluetooth wireless communication is possible with the first electronic device 101a. While simultaneously connected to the first playback device 201a, the second playback device 201b, and the third playback device 201c, the first electronic device 101a may transmit and receive data to and from at least one of the first playback device 201a, the second playback device 201b, and the third playback device 201c at any time without a separate (e.g., additional) communication setup.

The second playback device 201b may simultaneously perform Bluetooth wireless connection with the first electronic device 101a and the second electronic device 101b within the second range 320 capable of Bluetooth wireless communication, as shown by distance d1 and distance d4. The second electronic device 101b and the third playback device 201c are out of range for Bluetooth wireless communication as shown by distance d5, and therefore, the two electronic devices may not be connected. The Bluetooth wireless connection is maintained while they are in a short range, the connection is released when the distance between the two devices increases and, when the distance between the two devices decreases, they may be automatically reconnected. For example, when the first playback device 201a connected to the first electronic device 101a moves outside the communicable first range 310, the connection between the first electronic device 101a and the first playback device 201a may be released. Alternatively, when the second electronic device 101b moves close to the third playback device 201c enough to enable Bluetooth wireless communication, the two devices may be automatically connected.

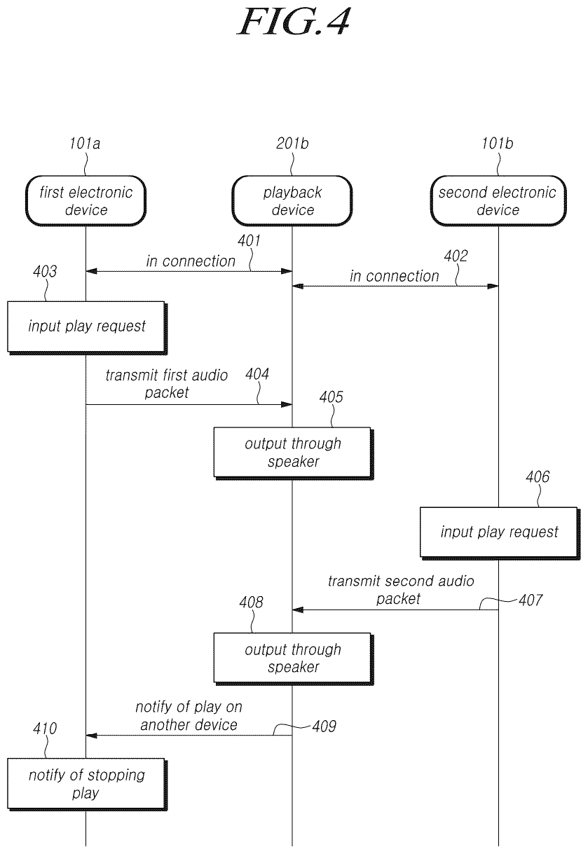

FIG. 4 is a signal flow diagram illustrating an example of an audio data transmission/reception method of electronic devices Bluetooth multi-point connected according to various embodiments.

In operation 401, the playback device 201b, according to an embodiment, may be connected to the first electronic device 101a based on the first protocol (e.g., A2DP). According to an embodiment, the playback device 201b may be connected to the second electronic device 101b based on the first protocol (e.g., A2DP) in operation 402. The playback device 201b, according to an embodiment, may be simultaneously connected to the first electronic device 101a and the second electronic device 101b based on the first protocol. For example, the playback device 201b may be a wearable device (e.g., true wireless stereo (TWS)) that may be worn on the user's ear. The first electronic device 101a may be a mobile device (e.g., a smartphone), and the second electronic device 101b may be a tablet device. Operation 401 may be performed after operation 402, and operation 401 and operation 402 may be performed simultaneously. The order disclosed in FIG. 4 is merely an example, and the playback device 201b may independently perform a wireless connection with the first electronic device 101a and the second electronic device 101b. The playback device 201b may transmit and receive data to and from the first electronic device 101a or the second electronic device 101b at any time while simultaneously wirelessly connected to the first electronic device 101a and the second electronic device 101b. In various embodiments, the playback device 201b may first receive data from the second electronic device 101b and then receive data from the first electronic device 101a.

In operation 403, an audio play request may be input to the first electronic device 101a according to execution of an application (e.g., a music player). In operation 404, the first electronic device 101a may transmit the first audio packet, encoded from the sound source data, to the playback device 201b to stream the same. In operation 404, the playback device 201b may decode the first audio packet received from the first electronic device 101a and output through a speaker in operation 405.

In operation 406, an audio play request according to execution of an application (e.g., a multimedia file) may be input to the second electronic device 101b. In operation 407, the second electronic device 101b may transmit the second audio packet encoded from the audio data to the playback device 201b to stream the same.

In operation 407, the playback device 201b may receive the second audio packet from the second electronic device 101b during wireless connection with the first electronic device 101a. In operation 408, the playback device 201b may stop streaming (e.g., playing) the first audio packet received from the first electronic device 101a, decode the received second audio packet, and output it through a speaker. In operation 409, the playback device 201b may notify the first electronic device 101a that audio streaming is performed with another electronic device. In operation 410, the first electronic device 101a may indicate (or notify) that the playback device 201b is connected to another electronic device and is operating (e.g., audio streaming is stopped) through an output device (e.g., a display) in response to receiving the alarm. In this case, Bluetooth multi-point connection between the playback device 201b and the first electronic device 101a may be maintained regardless of whether it is streamed. Likewise, wireless connection between the playback device 201b and the second electronic device 101b may be maintained at this time.

FIG. 5 is a flowchart illustrating an example operation of transmitting data to a wirelessly connected external playback device by an electronic device according to one or more embodiments.

The electronic device 101, according to an embodiment, may be simultaneously connected to a plurality of devices including an external playback device based on a Bluetooth multi-point connection. In a Bluetooth environment, a connection relationship with a plurality of devices may be changed in real-time by various factors.

In operation S510, the electronic device 101 (e.g., the electronic device 101 of FIG. 2), according to an embodiment, may be requested to play audio according to or based on the execution of an application (e.g., a music player or a multimedia file). The electronic device 101 may play audio through the sound output module 155 of the electronic device 101 or an external playback device (e.g., a wirelessly connected wearable electronic device). The electronic device 101 may set a default output device in the initial settings. For example, the electronic device 101 may set the wearable electronic device (e.g., the playback device 201 of FIG. 2) as the default output device while the wirelessly connected wearable electronic device is worn by the user. The electronic device 101 may identify the output device in response to the audio play request, and when the set default output device is the wirelessly connected external playback device (e.g., the playback device 201 of FIG. 2), the electronic device 101 may perform the following operations for transmitting an audio signal.

In operation S520, the electronic device 101 may identify whether it is in the Bluetooth multi-point wireless connection state. The electronic device 101 may be simultaneously connected to several (e.g., at least two) external electronic devices based on the Bluetooth multi-point wireless connection. The electronic device 101 may identify the state of the communication module 190 and identify whether Bluetooth multi-point wireless connection is being used. The electronic device 101 may perform operation S570 (described in greater detail below) when it is not in the Bluetooth multi-point wireless connection state, e.g., when connected via Bluetooth with one external electronic device.

In operation S530, when the electronic device 101 is in the Bluetooth multi-point wireless connection state, the electronic device 101 may identify (or confirm) a multipoint-connected device. The electronic device 101 may perform wireless communication at a predetermined period (e.g., a wireless connection identification period) in order to maintain connection with the multipoint-connected external electronic device. In an embodiment, the wireless connection identification period may be adaptively determined according to the Bluetooth communication environment. The wireless connection identification period may be a period arbitrarily set within a maximum period in which Bluetooth communication between two devices (e.g., the electronic device and the external electronic device) may be maintained. For example, the electronic device 101 may transmit a signal (e.g., ping) and receive an acknowledgement signal (“ACK”) from the external electronic device to test the connection state with the wirelessly connected external electronic device every wireless connection identification period. In an embodiment, the electronic device 101 may determine the number of external electronic devices being simultaneously connected according to the number of ACKs received during the wireless connection identification period. When receiving three ACKs during the wireless connection identification period, the electronic device 101 may identify that it is being simultaneously wirelessly connected with the three external electronic devices. The electronic device 101 may continuously use some bandwidths to maintain the Bluetooth connection state with three external electronic devices.

In operation S540, the electronic device 101 may determine an available bandwidth and a target bitrate. The electronic device 101 may determine an available bandwidth based on information about the external electronic device that is connected via multi-point. While the electronic device 101 is simultaneously connected to a plurality of external electronic devices, a sufficient (e.g., appropriate) part (e.g., amount or portion) of the bandwidth necessary to perform network communication with each of the plurality of external electronic devices according to the network identification period may be used (e.g., allocated). The electronic device 101 may determine the rest of the entire bandwidth, except for the use of bandwidth according to network identification with external electronic devices being multipoint-connected, as the available bandwidth. As the number of external electronic devices in Bluetooth multi-point wireless connection increases, the part occupied (used) for maintaining the wireless connection in the entire bandwidth may increase. In an embodiment, the electronic device 101 may use the bandwidth determined according to the Bluetooth communication standard as the entire bandwidth. For example, if the bandwidth defined in the Bluetooth communication standard is 3 Mbps, the electronic device 101 may perform Bluetooth communication within 3 Mbps.

Since the entire bandwidth of the electronic device 101 is a limited resource, it may be divided into a part (e.g., amount or portion) used for network communication identification and a part used for data transmission/reception to maintain the multi-point connection. As the number of multipoint-connected external electronic devices increases, the bandwidth range used to identify network communication increases, and the bandwidth range used to transmit and receive data decreases correspondingly. For example, when the entire bandwidth is 100, if the bandwidth used to maintain the multi-point connection is n, the bandwidth available for data transmission and reception may be 100−n. Maintaining multi-point leads to easy switch between the plurality of devices, increasing user convenience, but may be in a trade-off relationship with the data transmission/reception aspect.

The electronic device 101 may determine the target bitrate based on the available bandwidth. The electronic device 101 may determine the target bitrate according to the multi-point connection state (e.g., the number of external electronic devices being multipoint-connected). For example, the electronic device 101 may determine the highest bitrate within the available bandwidth as the target bitrate.

If there is no external electronic device in multi-point connection, the electronic device 101 may use the entire bandwidth to transmit data to the external electronic device and thus may transmit audio data at a high bitrate. If there are a plurality of external electronic devices in multi-point connection, the electronic device 101 has no choice but to use part of the entire bandwidth for multi-point connection and determine the target bitrate limitedly according to the remaining bandwidth except for the part of the entire bandwidth. If the target bitrate is low, the electronic device 101 may not reach a level required to transmit audio data. In an embodiment, if the bandwidth part used for multi-point connection is large, if the electronic device 101 transmits audio data at a target bitrate determined based on the available bandwidth, the real-time streaming quality of the audio data may be deteriorated.

In operation S550, the electronic device 101 may determine whether the current bitrate is greater than the target bitrate. In an embodiment, the current bitrate may be a bitrate used to transmit and receive current data. When transmitting and receiving initial data, the current bitrate may be determined according to the current network environment and/or the properties of the data (e.g., compression sampling rate). For example, the electronic device 101 may set a default bitrate (e.g., 584 kbps) in advance to transmit and receive high-quality audio data and consider the current bitrate as the default bitrate (e.g., 584 kbps) according to the initial audio data transmission request.

In operation S560, if the current bitrate is greater than the target bitrate, the electronic device 101 may change the current bitrate. If the current bitrate is greater than the target bitrate, it may be difficult to transmit data according to the current bitrate with the currently available bandwidth. The electronic device 101 may change the current bitrate to a level available within the currently available bandwidth.

In operation S560, the electronic device 101 may change the current bitrate to a lower bitrate. In an embodiment, the electronic device 101 may change the current bitrate to the target bitrate or a bitrate lower than the target bitrate. The electronic device 101 may change the current bitrate in the range below the target bitrate considering the degree required for audio data transmission. For example, if the current bitrate is 584 kbps and the target bitrate is 500 kbps, the electronic device 101 may change the current bitrate to a preset first bitrate (e.g., 291 kbps) or target bitrate (e.g., 500 kbps) to transmit audio data.

According to an embodiment, the electronic device 101 may compress the high-quality original audio data into a general sound (e.g., audio) quality or a low sound quality, and then transmit the same at a bitrate lower than the target bitrate. For example, the electronic device 101 may compress audio data into a high sound quality of 96 kHz, 24 bits, and then transmit it at 291 kbps, or may compress it into a general sound quality of 48 kHz, 16 bits and transmit it at 291 kbps. When the electronic device 101 compresses high-quality audio data into a general sound (or audio) quality or a low-quality sound (or audio) and transmits the compressed audio data to an external playback device (e.g., the playback device 201 of FIG. 2), and the external playback device 201 outputs it through a speaker as it, the audio quality may be deteriorated. In a case where the original audio data is normal sound quality or low sound quality, even when the electronic device 101 transmits the original audio data to the external playback device 201 as it is, if the external playback device 201 outputs the through a speaker, the audio quality may deteriorate.

In response to determining that the current bitrate is not greater than the target bitrate in operation S570, the electronic device 101 may maintain the current bitrate since it is possible to transmit data according to the current bitrate with the currently available bandwidth.

In operation S580, the electronic device 101 may encode audio data according to the current bitrate and transmit the encoded audio data to an external playback device. The electronic device 101 may include information about the audio data while transmitting the audio data. The information about the audio data may include information about the applied bitrate, the sampling rate for the original audio, and/or the file size.

The electronic device 101 according to an embodiment may repeat operations S530 to S580 during streaming according to an audio play request. The electronic device 101 may change the bitrate while streaming audio data adaptively to a change in whether multi-point connection is made (e.g., a change in the number of wirelessly connected external electronic devices).

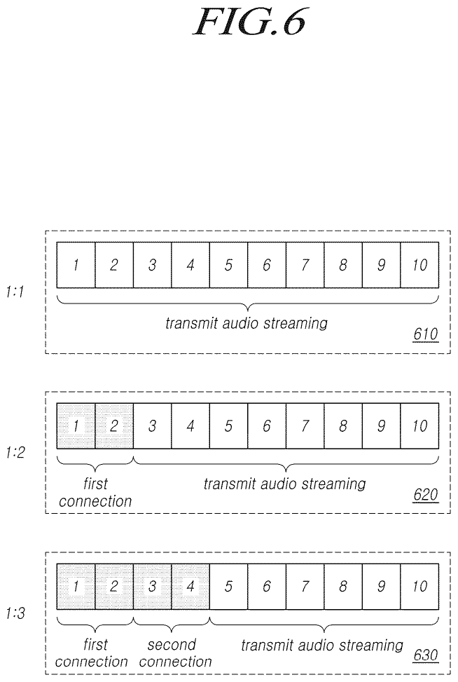

FIG. 6 is a diagram illustrating an example of bandwidth use information according to a multi-point connection according to one or more embodiments.

According to an embodiment, the electronic device 101 may transmit and receive data within a predetermined bandwidth (e.g., the entire bandwidth). When a plurality of electronic devices are connected to each other based on a Bluetooth multi-point connection, each of the electronic devices may use some (e.g., a certain amount of) bandwidth to maintain the multi-point connection. In FIG. 6, the entire bandwidth is regarded as 10, and the division according to the use of the bandwidth is displayed merely as an example, and in various embodiments, different methods may apply to divide the bandwidth.

Referring to FIG. 6, e.g., if only one external electronic device is connected based on a multi-point connection, the electronic device 101 may transmit audio streaming using the entire bandwidth (1 to 10) for data communication with an external electronic device (610). Since only one external electronic device is connected, there is no need to use the network to maintain the wireless connection with another electronic device.

If the electronic device 101 is connected to two external electronic devices (e.g., a first external device and a second external device), and performs data communication with one (e.g., the second external device) of the electronic devices, part (1, 2) of the entire bandwidth is used to maintain the wireless connection with the first external device, and the remaining bandwidth (3 to 10) may be used to transmit audio streaming to the second external device (620). Since the first external device and the second external device are simultaneously connected to the electronic device 101, the electronic device 101 may receive data from the first external device or the second external device or transmit data to the first external device or the second external device at any time. In 620 of FIG. 6, if the electronic device 101 transmits and receives data to and from the first external device, the first connection part may increase (e.g., using 1 to 8), and the connection part with the second external device may decrease (e.g., using 9 and 10).

If the electronic device 101 is connected to three external electronic devices (e.g., a first external device, a second external device, and a third external device) and performs data communication with one (e.g., the third external device) of them, part (1 to 4) of the entire bandwidth is used to maintain the wireless connection with the first external device and the second external device, and the remaining bandwidth (5 to 10) may be used to transmit audio streaming to the third external device (630).

As in the example of FIG. 6, the available range of the entire bandwidth may vary according to the number of multipoint-connected external electronic devices. The plurality of multipoint-connected electronic devices may be disconnected or reconnected according to the distance between the electronic devices or may be disconnected or reconnected according to the power on/off state of the electronic device. The number of external electronic devices multipoint-connected to the electronic device may vary according to various circumstances. The electronic device 101 may transmit/receive data considering the state of the multipoint-connected external electronic device in real-time.

FIG. 7 is a flowchart illustrating an example operation of receiving data from a wirelessly connected electronic device and playing the data by a playback device according to one or more embodiments.

The playback device 201, according to an embodiment, may be simultaneously connected to a plurality of devices including an electronic device (e.g., the electronic device 101) based on a Bluetooth multi-point connection. In an embodiment, the electronic device 101 may be a data transmission device or a data providing device. For example, the electronic device 101 may be a mobile device (e.g., a smartphone), and the playback device 201 may be a wearable TWS. In a Bluetooth environment, a connection relationship with a plurality of devices may be changed in real-time by various factors.

In operation S710, the playback device 201 may receive an audio packet from the external electronic device 101, which is one of one or more external electronic devices connected based on the Bluetooth multi-point.

In operation S720, the playback device 201 may decode the received audio packet and identify the bitrate (hereinafter, a reception bitrate) for the received audio packet. If the electronic device 101 encodes and transmits audio data at a first bitrate (e.g., 584 kbps), the playback device 201 may decode the received audio packet to identify the first bitrate.

In operation S730, the playback device 201 may determine whether the reception bitrate is greater than the buffer control bitrate. If the reception bitrate is greater than the buffer control bitrate, the playback device 201 may change the reception buffer size in operation S740.

The buffer control bitrate refers to the speed or size of processing the reception buffer. The buffer control bitrate may be determined according to the size of the reception buffer, and the size of the reception buffer may vary according to the number of external electronic devices wirelessly connected to the playback device 201. For example, if the number of external electronic devices wirelessly connected to the playback device 201 is large, the rest except for the size of the reception buffer used to maintain the multi-point wireless connection may be used for data transmission and reception. Accordingly, as the number of wirelessly connected external electronic devices increases, the buffer control bitrate of the playback device 201 may decrease. If the reception bitrate is greater than the buffer control bitrate, the processing speed or size of the reception buffer may be too small to handle the audio packet speed or amount in the playback device 201, resulting in an overflow. In this case, the playback device 201 may increase the size of the reception buffer according to the reception bitrate in order to facilitate the reception of the audio packet.

The playback device 201 may perform network communication at regular intervals to maintain wireless communication with one or more external electronic devices simultaneously connected based on Bluetooth multi-point. A part of the reception buffer may be used for network communication with one or more external electronic devices in wireless connection with the playback device 201. The buffer control bitrate may be determined according to the use of the entire reception buffer.

In operation S740, the playback device 201 may change the size of the reception buffer according to the reception bitrate in response to determining that the bitrate of the received audio packet is greater than the buffer control bitrate. For example, the playback device 201 may increase the size of the reception buffer by 150% to 200%. The playback device 201 may determine the reception buffer size to be added in proportion to the difference between the reception bitrate and the buffer control bitrate.

In operation S750, when the reception bitrate is less than or equal to the buffer control bitrate, the playback device 201 may maintain the current reception buffer size. When the reception bitrate in the playback device 201 is equal to or less than the buffer control bitrate, the current size of the reception buffer of the playback device 201 may be sufficient to store or process the received audio packet.

In operation S760, the playback device 201 may determine whether the bitrate of the received audio packet is less than a first threshold. In an embodiment, the playback device 201 may convert or enhance the audio signal into a higher sampling rate using an upscaler (e.g., the upscaler 2402 of FIG. 2). If the electronic device 101 transmits at a low bitrate, audio data having a lower sound quality than that of the original audio signal may be transmitted. If the playback device 201 decodes the received audio data and outputs it as it is, an audio signal having a lower sound quality than the original sound quality may be played. The playback device 201 may perform upscaling to restore the sound quality level of the audio packet encoded and transmit at a bitrate lower than the bitrate according to the sampling rate of the original audio data. In an embodiment, the first threshold may be predefined according to a bitrate corresponding to the high-quality level supported by the playback device 201. The playback device 201 may decode the audio packet and determine the first threshold for determining whether to perform upscaling based on the information about the audio data. In operation 770, if the bitrate of the received audio packet is smaller than the first threshold, the playback device 201 may perform upscaling on the received audio data. The playback device 201 may not apply the upscaler if the bitrate of the received audio packet is greater than or equal to the first threshold.

The electronic device 201 may upscale the decoded audio data in operation S770. The electronic device 101 may compress the original audio data into a low sound quality according to the use of a limited bandwidth and then transmit the same at a low bitrate. If the bitrate of the received audio packet is less than the first threshold, the playback device 201 may restore the original audio sound quality using the upscaler 2402. The upscaler 2402 of the playback device 201 may be included in the communication module 240. According to an embodiment, it may operate in the processor 220 of the playback device 201.

In operation S780, the playback device 201 may play the decoded audio data or the decoded-and-then upscaled audio data through the speaker 250 of the playback device 201.

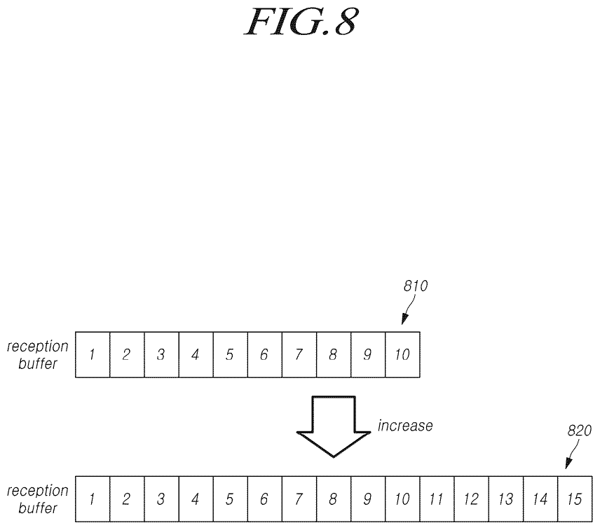

FIG. 8 is a diagram illustrating an example of changing a data reception buffer size by a data reception device according to one or more embodiments.

According to an embodiment, the data reception device 201 (or the playback device 201) may receive data from a first external electronic device among a plurality of external electronic devices simultaneously connected based on the Bluetooth multi-point using a reception buffer (e.g., the reception buffer 2404 of FIG. 2). Further, the playback device 201 may perform network communication at regular intervals using the reception buffer 2404 to maintain wireless communication with one or more external electronic devices simultaneously connected based on Bluetooth multi-point. Referring to FIG. 8, the playback device 201 may simultaneously perform a wireless connection with the plurality of external electronic devices using the reception buffer 810 in the first state and perform data from the first external electronic device. For example, the playback device 201 may transmit a ping and receive an ACK from the external electronic device to test the connection state with the wirelessly connected external electronic device every wireless connection identification period. Conversely, the playback device 201 may transmit an ACK in response to receiving a ping at a predetermined period from the external electronic device in wireless connection. Accordingly, a part of the reception buffer 810 in the first state may be used by network communication with one or more external electronic devices that are wirelessly connected to the playback device 201. Since transmitting and receiving ping/ACK is data transmission/reception only for identifying the network communication state, the minimum bandwidth and reception buffer 810 may be used. However, when the number of wirelessly connected external electronic devices increases, the bandwidth used for maintaining wireless connection and the proportion of the reception buffer 810 may increase. In an embodiment, the playback device 201 may not allocate sufficient bandwidth and size of the reception buffer for data transmission and reception according to the bandwidth used to maintain the wireless connection with the plurality of external electronic devices based on Bluetooth multi-point and the amount of the reception buffer 810.

According to an embodiment, the playback device 201 may increase the capacity of the reception buffer 810 if the bitrate according to data reception is greater than the bitrate for controlling the current reception buffer 810. Alternatively, the playback device 201 may increase the capacity of the reception buffer 810 in the first state like the reception buffer 820 in the second state as the number of external electronic devices remaining connected increases based on the Bluetooth multi-point. Further, when issues such as processing speed delay or buffer overflow according to data transmission/reception occur even when the reception buffer 820 in the second state is increased, the playback device 201 may require that data be transmitted to the electronic device transmitting data based on the wireless connection, at a lower transmission speed or may release connection with other electronic devices simultaneously connected according to multi-point connection without data transmission/reception.

The reception buffer 2404, 810, or 820 of the playback device 201 may be included in the communication module 240. Alternatively, according to an embodiment, the reception buffer 2404, 810, or 820 of the playback device 201 may exist as a piece of hardware separate from the communication module 240. In an embodiment, the reception buffer 2404, 810, or 820 may be implemented by allocating some of the addresses of the memory 230. According to an embodiment, the playback device 201 may change the size of the reception buffer 2404, 810, or 820 in various ways.

In an embodiment, the playback device 201 may reduce the size of the reception buffer 2404, 810, or 820 due to various factors such as a decrease in the number of devices wirelessly connected based on Bluetooth multi-point or a decrease in the bitrate of data received from an external electronic device.

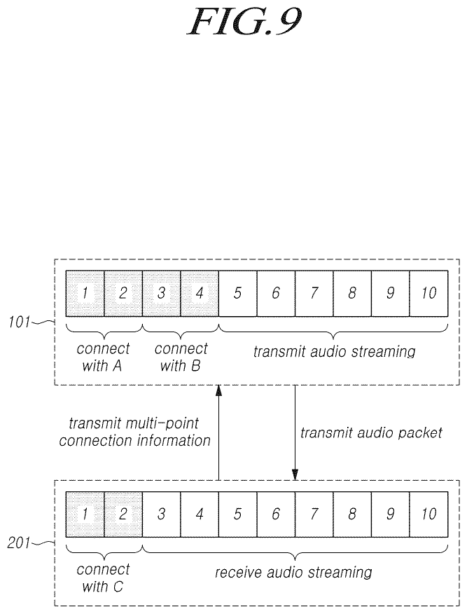

FIG. 9 is a diagram illustrating an example of using a bandwidth by a data transmission device and a data reception device wirelessly connected according to one or more embodiments.

According to an embodiment, the data transmission device 101 (e.g., the electronic device 101 of FIG. 2) and the data reception electronic device 201 (e.g., the playback device 201 of FIG. 2) may be wirelessly connected based on a Bluetooth multi-point connection. The data transmission device 101 and the data reception electronic device 201 each may be simultaneously connected to other electronic devices based on multi-point. For example, referring to FIG. 9, the data transmission device 101 is wirelessly connected to electronic device A, electronic device B, and the data reception device 201 at the same time. The data reception device 201 is wirelessly connected to electronic device C and the data transmission device 101 at the same time.

In an embodiment, the data transmission device 101 may transmit or receive data to or from any one of the wirelessly connected electronic device A, electronic device B, or data reception device 201. In an embodiment, the data reception device 201 may receive or transmit data from the wirelessly connected electronic device C or the data transmission device 101.

Each of the data transmission device 101 and the data reception electronic device 201 may have a different bandwidth and/or size of a transmission (reception) buffer according to a multi-point connection. As in an embodiment of FIG. 5, the data transmission device 101 may adaptively change the bitrate based on its multi-point connection state and transmit data. As in an embodiment of FIG. 7, the data reception device 201 may change the size of the reception buffer according to the bitrate of the received audio packet or restore the sound quality of the received data using an upscaler. Referring to FIG. 9, the data transmission device 101 and the data reception device 201 may affect each other in the number of other electronic devices being simultaneously connected based on a multi-point connection.

In an embodiment, the data transmission device 101 may have a larger bandwidth range and target bitrate available in response to release of the wireless connection with, e.g., electronic device A. Accordingly, the data reception device 201 may receive the audio packet at a changed bitrate while receiving the audio packet from the data transmission device 101, and adaptively change reception buffer management and whether to apply upscaling.

In an embodiment, the data reception device 201 may establish a new wireless connection with another electronic device (e.g., electronic device D (unshown)) while receiving an audio packet from the data transmission device 101. For example, when the electronic device D registered for wireless communication connection based on the Bluetooth multi-point to the data reception device 201 is powered on or the position of the electronic device D is close to the position of the data reception device 201 within the range capable of Bluetooth communication connection, the two devices may be automatically connected wirelessly. Accordingly, while the data reception device 201 receives an audio packet at the same bitrate from the data transmission device 101, an overflow may occur in the reception buffer. The data reception device 201 may change the buffer control bitrate and, as necessary, transmit multi-point connection information to the data transmission device 101 to request to transmit audio packets at a lower bitrate.

In various embodiments, the data transmission device 101 and the data reception electronic device 201 may share their multi-point connection information.

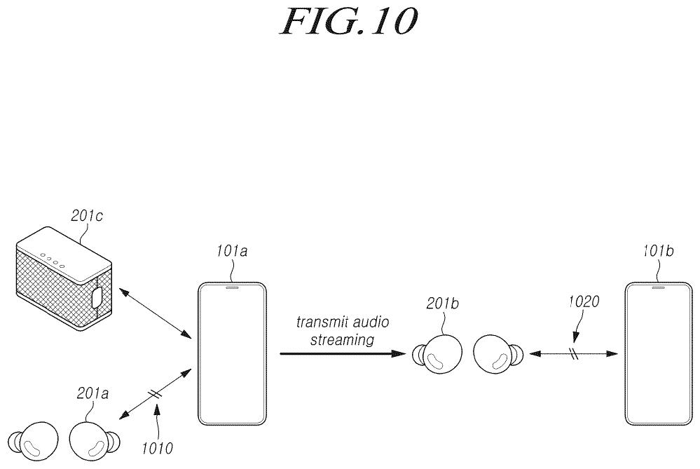

FIG. 10 is a diagram illustrating an example of a multi-point connection circumstance between a plurality of electronic devices according to one or more embodiments.

According to an embodiment, a plurality of electronic devices in a wireless connection network environment may be simultaneously connected to each other based on (e.g., via) a Bluetooth multi-point connection.

Each of the plurality of electronic devices may maintain the wireless connection with other electronic devices while transmitting or receiving data to or from one wirelessly connected electronic device. According to an embodiment, the electronic device may temporarily or continuously release the wireless connection with some electronic devices connected through Bluetooth multi-point for smooth data transmission and reception.

Referring to FIG. 10, e.g., the first electronic device 101a is simultaneously connected to a TWS-type first wearable electronic device 201a, a TWS-type second wearable electronic device 201b, and a Bluetooth speaker 201c. The second wearable electronic device 201b is simultaneously connected to the first electronic device 101a and the second electronic device 101b.

In an embodiment, the first electronic device 101a may transmit audio streaming to the second wearable electronic device 201b. The first electronic device 101a and the second wearable electronic device 201b may change the bitrate, increase or decrease the size of the transmission/reception buffer, or upscale the audio data received with low sound quality in order to smoothly transmit high-quality audio streaming without sound drops. For example, the first electronic device 101a may transmit audio packets at a lower sound quality and/or bitrate than the level of sound quality and/or bitrate required by the original audio, taking into account some bandwidth being used to maintain the multi-point connection with the second wearable electronic device 201b and the Bluetooth speaker 201c. The second wearable electronic device 201b may receive an audio packet transmitted at a sound quality and/or a bitrate lower than the sound quality and/or bitrate of the original audio, adjust the size of the reception buffer or restore the sound quality of the audio signal using an upscaler.

In an embodiment, the first electronic device 101a and/or the second wearable electronic device 201b may control a multi-point connection circumstance. The first electronic device 101a may release the connection with at least one of the devices in multi-point connection. For example, in operation 1010, the first electronic device 101a may release the connection to the first wearable electronic device 201a of the same type as the second wearable electronic device 201b currently transmitting and receiving data. Alternatively, the first electronic device 101a may release the connection of a wearable electronic device that is not worn among wirelessly connected devices. The first electronic device 101a may release the connection with the electronic device having the longest unused period. In operation 1020, the second wearable electronic device 201b may release the connection with the second electronic device 101b connected thereto.

In an embodiment, the electronic device 101a and/or the second wearable electronic device 201b may predefine a setting for releasing the connection and may configure a screen to add, change, or delete setting contents by the user input.

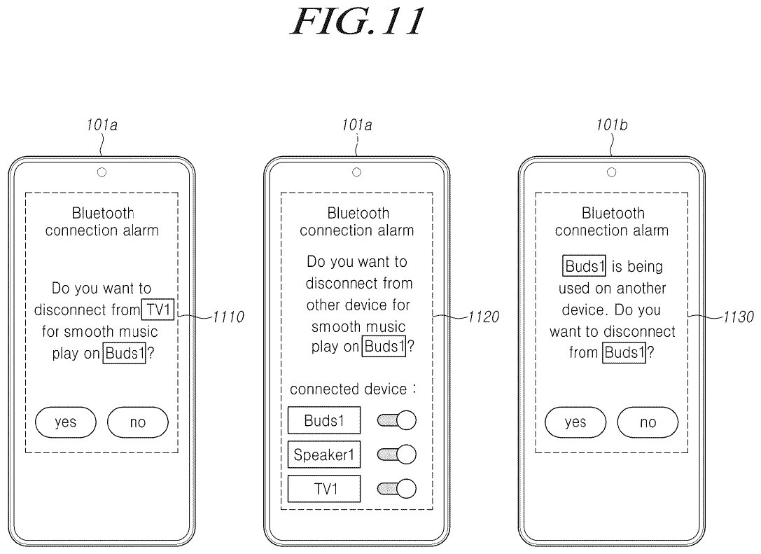

FIG. 11 is a diagram illustrating an example of a Bluetooth connection alarm screen of an electronic device according to one or more embodiments.

According to an embodiment, the electronic device 101 (or the electronic device 201) may be simultaneously connected to a plurality of external electronic devices based on a Bluetooth multi-point connection. In an embodiment, the electronic device 101 may provide a screen according to a multi-point connection circumstance to the user. For example, in the circumstance of FIG. 10, a Bluetooth connection alarm screen may be displayed on the first electronic device 101a or the second electronic device 101b.

The first electronic device 101a may display a first screen 1110 displaying information about the Bluetooth connection being multipoint-connected. The first screen 1110 may include an alarm requesting to release connection with another device in multi-point connection in relation to data transmission/reception with a playback device in connection with the first electronic device 101a. For example, the first screen 1110 may display a yes/no icon with a guide message, “Do you want to disconnect from TV 1 for smooth music play on Buds1?” and receive a user input. For example, Buds1 may be the second wearable electronic device 201b, and TV 1 may be another electronic device in wireless connection with the first electronic device 101a.

As another example, the first electronic device 101a may display a second screen 1120 including a list of connected devices. The second screen 1120 may include an alarm requesting to release connection with at least one of the other devices in multi-point connection in relation with data transmission/reception with the playback device in connection with the first electronic device 101a. For example, the second screen 1120 may display an icon for checking whether to release connection with corresponding devices and the list of connected devices along with a guide message “Do you want to disconnect from other devices for smooth music play on Buds1?”

As another example, the second electronic device 101b may include an alarm requesting to release connection with the second wearable electronic device 101b in relation to data transmission/reception with the first electronic device 101a in wireless connection with the second wearable electronic device 201b (e.g., Buds1) in wireless communication. The second wearable electronic device 201b may enhance the audio streaming environment by releasing the connection with other electronic devices in addition to the electronic device transmitting and receiving data. The second electronic device 101b may display a third screen 1130 at the request of the second wearable electronic device 201b. For example, the third screen 1130 may display a yes/no icon along with a guide message “Buds1 is being used on another device. Do you want to disconnect from Buds1?” and receive a user input.

In various embodiments, the electronic device 101 (or the electronic device 201) may display information related to the multi-point connection and/or a screen for leading to a user input. The electronic device 101 (or the electronic device 201) may control a multi-point connection circumstance by a user input.

The various example embodiments of the disclosure and terms used therein are not intended to limit the technical features described in the disclosure to specific embodiments, and should be understood to include various modifications, equivalents, or substitutes of the embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device, comprising:
a communication module comprising communication circuitry configured to support simultaneous wireless connection with a plurality of external electronic devices;
memory; and
at least one processor comprising processing circuitry, wherein the memory stores instructions, wherein at least one processor, individually and/or collectively, is configured to execute the instructions and to control the electronic device to:
identify at least one external electronic device wirelessly connected with the electronic device in response to a request for playing first audio data for a first external electronic device wirelessly connected with the electronic device;
determine a first bitrate for transmitting the first audio data based on a bandwidth range remaining excluding a bandwidth used for maintaining the wireless connection with the identified at least one external electronic device;
generate a first audio packet by encoding the first audio data based on a current bitrate in response to determining that the current bitrate is less than or equal to the first bitrate; and
transmit the first audio packet to the first external electronic device through the communication module.

2. The electronic device of claim 1, wherein at least one processor, individually and/or collectively, is configured to control the electronic device to maintain the wireless connection between the electronic device and the at least one external electronic device based on a Bluetooth multi-point connection through the communication module while transmitting the first audio packet to the first external electronic device.

3. The electronic device of claim 2, wherein at least one processor, individually and/or collectively, is configured to control the electronic device to connect each of the at least one external electronic device to the electronic device based on a first protocol.

4. The electronic device of claim 1, wherein at least one processor, individually and/or collectively, is configured to control the electronic device to: transmit a data signal for identifying a network connection state to the first external electronic device among the at least one external electronic device wirelessly connected with the electronic device every specified first period through the communication module; and maintain Bluetooth multi-point-based wireless connection between the electronic device and the first external electronic device in response to receiving a response signal within a specified time from the first external electronic device.

5. The electronic device of claim 4, wherein at least one processor, individually and/or collectively, is configured to control the electronic device to change the current bitrate to be less than the first bitrate in response to determining that the current bitrate is greater than the first bitrate.

6. The electronic device of claim 5, wherein at least one processor, individually and/or collectively, is configured to control the electronic device to, in response to determining that a difference between the current bitrate and the first bitrate is greater than a first reference, compress the first audio data into a sound quality lower than a current sound quality and encode at the changed current bitrate.

7. The electronic device of claim 1, wherein at least one processor, individually and/or collectively, is configured to control the electronic device to, in response to determining that the first bitrate is less than a specified threshold, release connection to at least one among the at least one external electronic device wirelessly connected with the electronic device.

8. The electronic device of claim 7, further comprising a display, wherein at least one processor, individually and/or collectively, is configured to control the electronic device to display, through the display, a screen including information about the at least one external electronic device simultaneously connected with the electronic device or a message related to releasing the connection.

9. The electronic device of claim 1, wherein at least one processor, individually and/or collectively, is configured to control the electronic device to change the current bitrate in response to receiving a request for changing a bitrate of receiving the first audio packet from the first external electronic device.

10. The electronic device of claim 1, wherein at least one processor, individually and/or collectively, is configured to control the electronic device to release a Bluetooth multi-point-based wireless connection with the first external electronic device in response to a distance to the first external electronic device among the at least one external electronic device being out of a communicable range.

11. An electronic device, comprising:
a speaker;
a communication module comprising communication circuitry configured to support simultaneous wireless connection with a plurality of external electronic devices;
memory; and
at least one processor including processing circuitry, wherein the memory stores instructions, and at least one processor, individually and/or collectively, is configured to execute the instructions and to control the electronic device to:
receive a first audio packet from a first external electronic device among at least one external electronic device wirelessly connected with the electronic device through the communication module;
increase a size of a reception buffer in response to determining that a bitrate applied to the first audio packet is greater than a bitrate of controlling the reception buffer; and
output audio data decoded from the first audio packet through the speaker.

12. The electronic device of claim 11, wherein at least one processor, individually and/or collectively, is configured to control the electronic device to maintain the wireless connection between the electronic device and the at least one external electronic device based on a Bluetooth multi-point connection through the communication module while receiving the first audio packet.

13. The electronic device of claim 12, wherein at least one processor, individually and/or collectively, is configured to control the electronic device to connect each of the at least one external electronic device to the electronic device based on a first protocol.

14. The electronic device of claim 11, wherein at least one processor, individually and/or collectively, is configured to control the electronic device to: transmit a data signal for identifying a network connection state to the first external electronic device among the at least one external electronic device wirelessly connected with the electronic device every specified first period through the communication module and maintain Bluetooth multi-point-based wireless connection between the electronic device and the first external electronic device in response to receiving a response signal within a specified time from the first external electronic device.

15. The electronic device of claim 11, wherein at least one processor, individually and/or collectively, is configured to control the electronic device to: determine the reception buffer control bitrate to store or process the received first audio packet based on an unused portion other than for a portion used to maintain the wireless connection with the at least one external electronic device wirelessly connected with the electronic device, of the reception buffer of the electronic device.

16. The electronic device of claim 11, wherein at least one processor, individually and/or collectively, is configured to control the electronic device to perform upsampling on the decoded audio data in response to determining that a bitrate applied to the first audio packet is less than a first threshold.

17. The electronic device of claim 11, wherein at least one processor, individually and/or collectively, is configured to control the electronic device to perform upsampling on the decoded audio data in response to determining that the decoded audio data is of lower quality than an original sound quality of the first audio packet.

18. The electronic device of claim 11, wherein at least one processor individually and/or collectively, is configured to control the electronic device to, in response to determining that a size of the reception buffer is greater than a first reference size, release connection to at least one among the at least one external electronic device wirelessly connected with the electronic device.

19. The electronic device of claim 11, wherein at least one processor, individually and/or collectively, is configured to control the electronic device to, in response to determining that a size of the reception buffer is greater than a first reference size, transmit a request for changing the bitrate applied to the first audio packet to the first external electronic device.

20. The electronic device of claim 11, wherein the electronic device comprises a wearable true wireless stereo device.
